(19) United States
(12) Patent Application Publication
(10) Pub. No.: US 2008/0041880 A1
(43) Pub. Date: Feb. 21, 2008

(54) HANDHELD FOODSTUFF DISPENSER

(76) Inventors: Roger Babineau, Taunton, MA (US); Nicholas Seager, Franklin, MA (US); James J. Tracy, Attleboro, MA (US)

Correspondence Address: HOFFMANN & BARON, LLP, 6900 JERICHO TURNPIKE, SYOSSET, NY, 11791, US

(21) Appl. No.: 11/422,274

(22) Filed: Jun. 5, 2006

(51) Int. Cl. B67D 5/62; B65D 88/54; G01F 11/00

(52) U.S. Cl. 222/146.5; 222/390; 222/333

(57) ABSTRACT

A handheld dispenser of foodstuff including a housing having an interior chamber. An outlet is in communication with the chamber. The motor is disposed within the housing. A drive mechanism is operatively associated with the motor for moving the foodstuff within the chamber towards the outlet. The handle is movably disposed on the housing between a first operative position and a second operative position. The handle on the housing defining a hand opening when the handle is in the first operative position.

### FIELD OF INVENTION

The present invention relates to a device for dispensing foodstuff and, more particularly, to a handheld, motorized device for dispensing foodstuff.

### BACKGROUND OF THE INVENTION

Handheld dispensers of foodstuff are known in the art for use in preparing and decorating food such as cakes, pastries, and the like. One such typical device includes a pastry bag which can be filled with icing and includes interchangeable tips which allows the icing to be extruded in a variety of configurations. The icing is extruded through the tip by applying pressure to the bag. Such devices require the user to have a significant expertise in order to uniformly dispense the material and guide the tip across the surface to be decorated. Furthermore, these devices have limited success when the foodstuff to be dispensed is solid at room temperature, such as chocolate. While chocolate may be melted prior to dispensing, it needs to be dispensed fairly quickly before it starts to harden within the dispenser and impedes decoration.

Various mechanical devices for dispensing foodstuff are also known. Mechanical dispensers have a plunger attached to a piston with the plunger extending from the housing. A user must push on the plunger to extrude the foodstuff from the device. Alternatively, a drive mechanism may move the plunger. In both instances, when the unit is full of food the plunger extends outwardly, making for a device that is relatively long and difficult to carefully control. Careful and precise control is important for decorating devices since it directly affects the outcome of the decorating job.

Prior art dispensers are typically formed such that a user grabs the device in a single predetermined manner which is dictated by the design of the dispenser. A user must conform their decorating technique to the dispenser. Proper control of the dispenser is required in order to create a desirable outcome. Depending on the particular application, it may be uncomfortable to hold and control the dispenser which would negatively affect the outcome of the food preparation and decorating.

Accordingly, it would be desirable to provide a foodstuff dispenser which is capable of dispensing foodstuff that is flow able at room temperature as well as foodstuff that needs to he heated in order to be dispensed. It is also further desirable to provide a foodstuff dispenser which is compact and easy to control and that can be selectively configured in order to facilitate ease of operation by a user.

### SUMMARY OF THE INVENTION

The present invention provides a handheld foodstuff dispenser.

The present invention further provides a handheld foodstuff dispenser including a motor for dispensing the foodstuff.

The present invention further provides a handheld foodstuff dispenser having a handle which may be moved between the first and second operative positions in order to permit the dispenser to be held in different positions.

The present invention further provides a handheld foodstuff dispenser having a heating element for heating the foodstuff prior to it being dispensed.

The present invention provides a handheld dispenser of foodstuff including a housing having an interior chamber. An outlet is in communication with the chamber. The motor is disposed within the housing. A drive mechanism is operatively associated with the motor for moving the foodstuff within the chamber towards the outlet. The handle is movably disposed on the housing between a first operative position arid a second operative position. The handle on the housing defines a hand opening when the handle is in the first operative position.

The present invention may yet further provide a hand-held dispenser of foodstuff including a housing including an interior chamber and a nozzle in communication with the chamber. A piston is disposed within the chamber and translatable toward and away from the nozzle. A drive mechanism includes a motor, and the drive mechanism is operably connected to the piston for moving same. The piston cooperates with the chamber to prevent relative rotation between the piston and chamber. The dispenser may also include a heating element in thermal communication with the chamber for melting the foodstuff.

The present invention further provides a hand-held dispenser of foodstuff including a housing having an interior chamber. A nozzle is in communication with the chamber. The nozzle is selectively positionable between at least a first and second operating position, wherein the first position is angularly offset from the first position. The invention further includes an extruding device that includes a motor for moving the foodstuff through the nozzle.

The present invention also provides a hand-held dispenser of foodstuff including a housing having an interior chamber, and an outlet in communication with the chamber. A motor is disposed within the housing. A drive mechanism is operably associated with the motor. A liner is removably insertable within the chamber, and the liner includes a longitudinally extending side wall and a back wall. Foodstuff is disposable within the liner. The drive mechanism moves the piston to dispense the foodstuff out of the outlet.

### BRIEF DESCRIPTION OF THE DRAWINGS

FIG. 1 is a prospective view of the dispenser of the present invention, with the handle shown in a first operative position.

FIG. 2 is the dispenser of FIG. 1 showing the handle in a second operative position.

FIG. 3 is a cross-sectional view taken along line 3-3 of FIG. 1 showing the handle in the first and second operative positions.

FIG. 4 is a cross-sectional view taken along line 4-4 of FIG. 3.

FIG. 5 is a detailed sectional view of the clutch mechanism of the present invention.

FIG. 6 is a perspective view of the clutch mechanism of the present invention.

FIG. 7 is a perspective view of a liner of the present invention.

FIG. 8 is a detailed sectional view of the dispending end of the present invention.

FIG. 9 is an elevational view of the nozzle assembly of the present invention.

FIG. 10 is an elevational view of the front end of the housing of the present invention.

FIG. 11 is an elevational view of an alternative embodiment of the nozzle assembly of the present invention.

FIG. 12 is an elevational view of an alternative embodiment of the front end of the housing of the present invention.

FIG. 13 is an elevational view of a further alternative embodiment of the nozzle assembly of the present invention.

FIG. 14 is an elevational view of a further alternative embodiment of the front end of the housing of the present invention.

### DETAILED DESCRIPTION OF THE PREFERRED EMBODIMENT

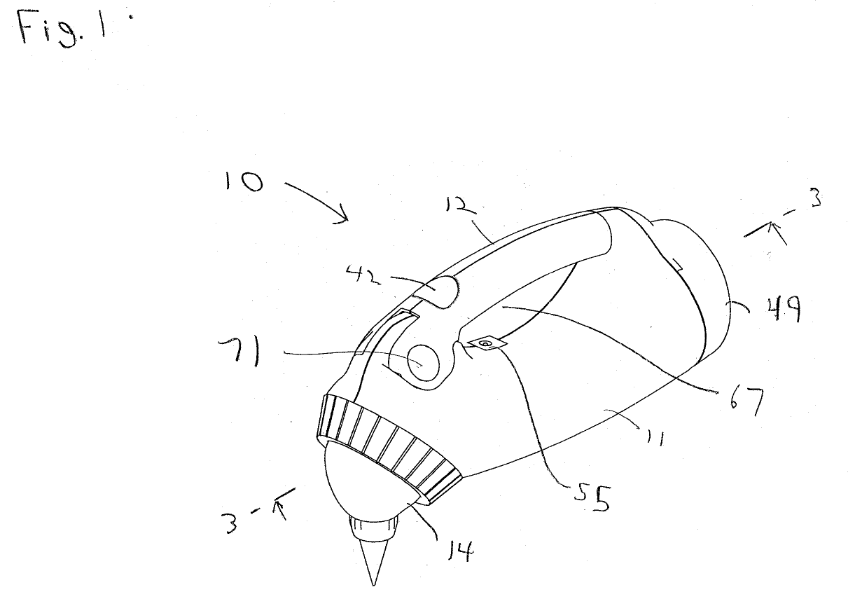

With reference to FIGS. 1-3, a handheld foodstuff dispenser of the present invention is shown. Dispenser 10 of the present invention may be used to dispense foodstuff for preparing and decorating cakes, pastries, cookies, and the like. Dispenser 10 preferably includes a housing 11 having a handle 12 disposed thereon. Housing 10 includes a dispensing end having a nozzle assembly 14 through which foodstuff 15 may be dispensed. The dispenser 10 further includes an extruding device including a drive mechanism 16 for extruding the foodstuff out through nozzle assembly 14. Drive mechanism 16 is operatively associated with a motor 18.

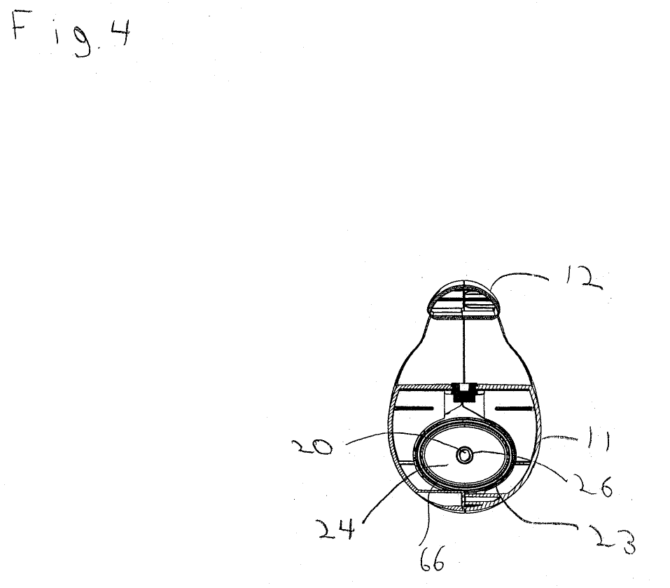

With additional reference to FIG. 4, a longitudinally extending chamber 22 is disposed within housing 11. The chamber 22 includes a wall 23 which defines a volume for holding foodstuff 15 to be dispensed upon operation of drive mechanism 16. Drive mechanism 16 preferably includes an elongate shaft 20 having a portion disposed within chamber 22 and extending along a length thereof. A piston 24 is disposed within chamber 22 and cooperates with shaft 20. Shaft 20 may be threaded along its length. The thread may be continuous or it may be interrupted such as by flats extending along the side of the shaft. Piston 24 preferably has a central threaded opening 26 through which shaft 20 extends. The outer configuration of the piston 24 and the inner configuration of chamber 22 are preferably complementary to one another such that piston 24 may traverse back and forth within chamber 22. Rotation of shaft 20 relative to piston 24 results in the piston moving along shaft 20. As the piston advances, it will urge the foodstuff 15 in chamber 22 forward and out of the nozzle assembly 14.

In the preferred embodiment, in order to prevent piston 24 from rotating with the shaft, the shape of the piston and the shape of chamber 22 may be non-circular. Preferably, the piston 24 has an elliptical configuration which conforms to an elliptical configuration of the chamber 22. Therefore, when shaft 20 rotates, piston 24 is prevented from rotating by the chamber; however, piston 24 will translate along the length of shaft 20. It is within the contemplation of the present invention that other non-circular configurations could also be used. In addition, other means for preventing relative rotation could be employed such as cooperating slots and projections on the piston and chamber wall (not shown), thereby permitting use of a round piston and chamber.

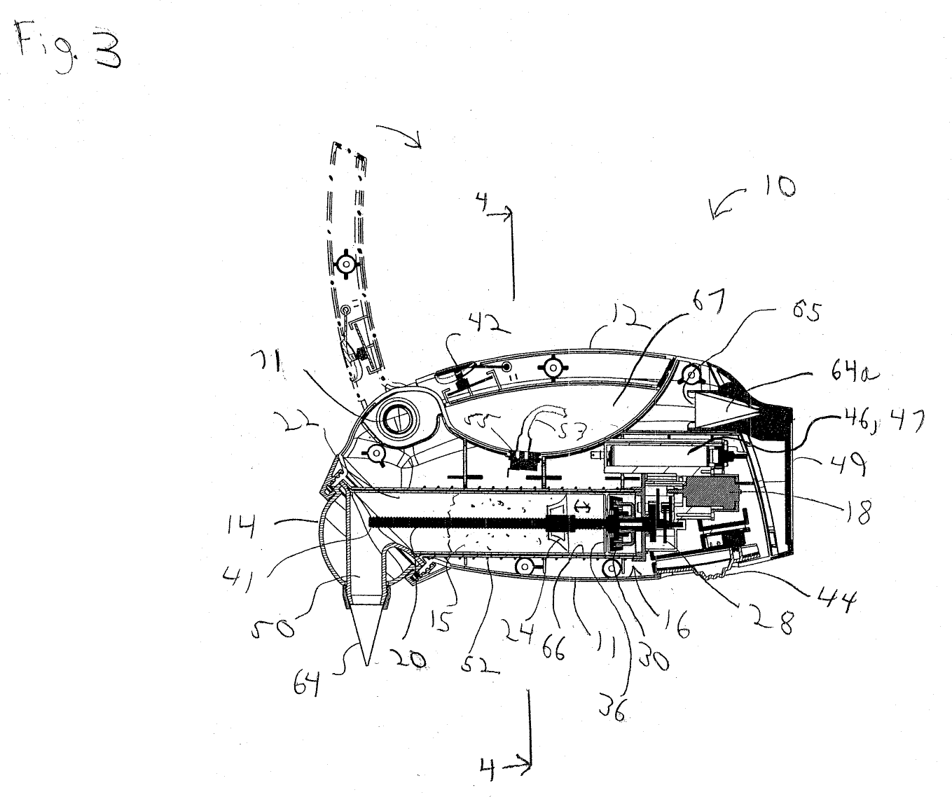

With reference to FIGS. 3, 5 and 6 threaded shaft 20 is rotated by motor 18 and is operably connected to motor 18 via gear assembly 28. Gear assembly 28 may include a plurality of inter-meshed gears and act as a speed reducer and torque increaser. Interposed between shaft 20 and gear assembly 28 may be a clutch mechanism 30. The clutch mechanism 30 allows the shaft 20 to rotate in a direction advancing the piston 24 toward nozzle assembly 14 without allowing slippage within the clutch. Therefore, maximum torque can be provided in the advancing piston when dispensing foodstuff. When the rotation of the shaft 20 is reversed in order to return piston 24 to an initial position, the piston 24 will eventually bottom out against an end wall 36. When this occurs, clutch mechanism 30 permits the motor and gear assembly to rotate while the shaft remains stationary. The clutch mechanism 30 includes a first part 32 fixedly secured to threaded shaft 20 and a second part 34 rotationally securable to the gear assembly 28. The first clutch part 32 includes an annular toothed portion 38. The second clutch part 34 includes radially spaced members 40 which positively engage the tooth part 38 when rotating the shaft 20 in the direction to advance piston 24. However, when the shaft is rotated such that the piston moves towards end wall 36, when the piston bottoms out, the members 40 are able to slip with respect to the toothed part 38 thereby preventing further rotation of the shaft. This slipping causes a clicking sound which alerts the user that the piston is fully retracted. It is within the contemplation of the present invention that a position sensor, either mechanical or electrical, could be used in order to indicate to the user that the piston has reached its maximum retracted position.

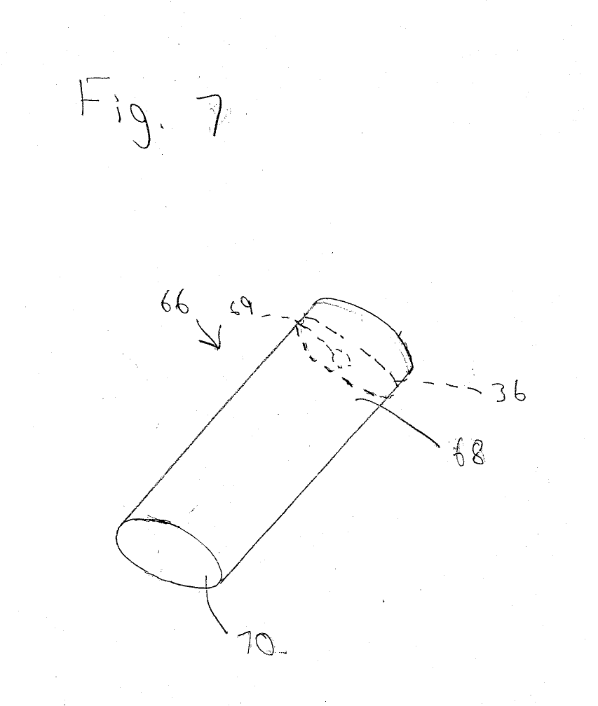

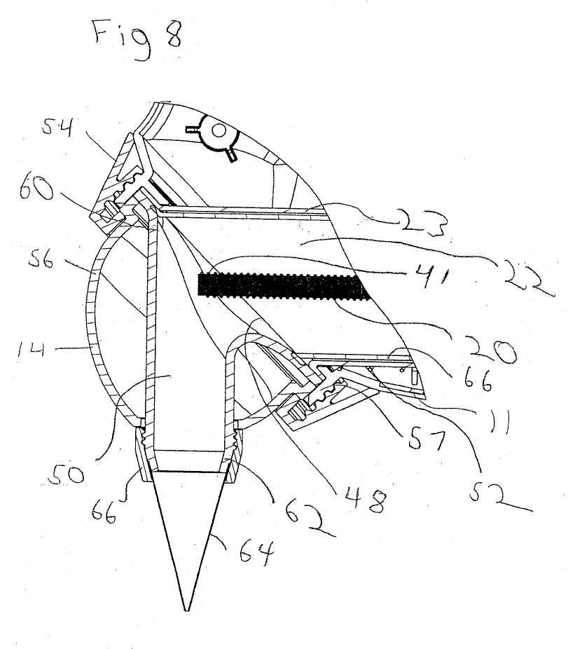

Threaded shaft 20 may include a non-threaded portion 41 (FIG. 8) at its distal end. When piston 24 advances to the non-threaded portion, the piston will no longer advance upon rotation of the shaft 20, and foodstuff will stop flowing out of the nozzle assembly 14. This alerts a user that the piston has achieved its maximum forward travel, and that the chamber 22 is empty.

Since the piston 24 travels along the shaft 20 that extends into the chamber 22, a significant amount of piston displacement is possible for the size of the dispenser. Therefore, the dispenser may take on a compact design. This makes the dispenser easy to control, which is important when decorating food items.

With reference to FIG. 3, the control of the piston's 24 movement may be by way of an operating switch 42 and a selector switch 44. Both switches are operably connected to motor 18. Operating switch 42 causes motor 18 to be energized. Selector switch 44 affects the output of motor 18 when the operating switch 42 is actuated. In one position, selector switch 44 may turn the device off such that actuating of the operating switch does nothing. Selector switch 44 may also be moved in a low, medium or high forward position, in each of these switch positions, the motor 18 will turn in the direction such that piston 24 will move forward at the chosen speed when the operating switch 42 is actuated. This allows a user to adjust the flow rate of material exiting the nozzle assembly 14 to suit the particular situation. Selector switch 44 may also be moved to a reverse position, such that actuating operating switch causes the piston 24 to move to its initial retracted position. Motor 18 may be a DC motor with the selector switch 44 being able to reverse the polarity to the motor to change the motor's direction in a manner well known in the art.

In an alternative embodiment (not shown), the functions of the operating switch and selector switch may be performed by a single switch. Such a switch may have an off, reverse, slow forward, medium forward and fast forward position. It is also within the contemplation of the present invention that the speed control of the motor, and therefore piston, may be continuously variable.

Motor 18 may be operatively connected to a power source 46 which is portable, such as batteries 47. Housing 11 may include a removable portion 49 that when removed exposes the batteries 47 so that they can be removed and replaced. Alternatively, motor 18 may be connected to a constant power such as a household outlet via an external plug.

With reference to FIGS. 3, 8 and 9, the chamber 22 may include a front opening 48 that is operatively connected to the nozzle assembly 14 through which foodstuff is extruded. The nozzle assembly 14 provides a channel 50 such that foodstuff disposed within chamber 22 may exit the dispenser upon advancement of piston 24.

It is within the contemplation of the present invention that the foodstuff may be in the form of chocolate, icing, cheese, or other material. Certain foods, such as chocolate, need to be melted so they can flow before they are dispensed. Accordingly, the present invention may include a heating element 52 disposed adjacent chamber wall 23 and extends along a length thereof. In a preferred embodiment, the heating element 52 constitutes a coil, such as resistance wire, which is wrapped around the outside of chamber wall 23 and extends along a substantial portion of its length. Heating element may also be in the form of a strip extending along the chamber 22.

Heating element 52 may be connected to the same power source as the motor such as batteries or household current. If it is desired to run the motor on batteries, due to the current drain of a heating coil, it is preferable to connect the heating element to a separate power source by a cord 53 which may plug into a connector 55 disposed on housing 11. For example, the heating element 52 may be connected to the corded plug which receives a current from a standard household outlet. If a user wishes to engage the heating element, they may plug the cord 53 into a wall outlet for a predetermined amount of time in order to liquefy the contents of the chamber. It is in contemplation of the present invention that after a certain predetermined amount of time or when a certain temperature is reached, a signal is given in order to indicate that the device is ready for use. For foodstuff that is suitable for dispensing at room temperature, such as cake icing, there would be no need to energize the heating element 52. If is further within the contemplation of the present invention that in addition to supplying current to the heating element, the cord 53 could supply power to the motor instead of, or in addition to, batteries.

With reference to FIGS. 8 and 9, in order to place foodstuff 15 in chamber 22, the nozzle assembly 14 of the present invention is preferably removable from the housing 11. The nozzle assembly 14 may include a threaded collar 54 which is rotatably supported on a generally dome-shaped nozzle component 56 such that the threaded collar can rotate relative to the nozzle component. The front end of housing 11 may include threads 57 which engage collar 54 such that the nozzle assembly may be fixedly secured to housing 11. It is within the contemplation of the present invention that the nozzle component may be secured to the housing using a variety of attachment mechanisms such as a bayonet connection of a type well known in the art. The nozzle assembly 14 further includes the channel 50 having a first end 60 which mates with the front end of chamber 22. Channel 50 has a second end 62 which mates with a nozzle tip 64.

Nozzle tip 64 may be removably secured to nozzle component 56 at channel second end 62 such that it can be easily replaced. Nozzle tip 64 may be secured by a ring 66 that is threaded on to the end of nozzle component 56. When ring 66 is unscrewed from nozzle component 56, the nozzle tip 64 may be removed. It is within the contemplation of the present invention that nozzle tips may have various profile openings in order to affect the shape of the foodstuff being extruded there through. Removal of housing portion 49 may also expose a storage compartment 65 in the housing portion for holding extra nozzle tips 64a (FIG. 3). Nozzle component 56 may be formed of a plastic material which is dishwasher safe. It may also include an antimicrobial substance such as Microban® from Microban International, Ltd, or other such material as is known in the art. Nozzle tip 64 may be formed of a similar plastic or may be formed of metal such as stainless steel. Other materials such as those known to one skilled in the art may be used in forming these components.

In the preferred embodiment, a user may retract the piston 24, remove the nozzle assembly 14 and pour into chamber 22 the foodstuff 15 to be dispensed Referring to FIGS. 3 and 7 chamber 22 may be covered internally by a liner 66. Liner 66 preferably extends along the length of the chamber 22 and isolates the chamber wall 23 from the foodstuff 15. Liner 66 may have a shape corresponding to that of chamber 22 and include a longitudinally extending sidewall 68 defining a central opening 70 in order to accommodate shaft 20 and piston 24. Liner may have a back wall 36 which defines the back wall of the chamber 22. Back wall 36 may include an opening 69 to allow shaft 20 to pass there through. Liner 66 may be formed of a food safe plastic and be dishwasher safe.

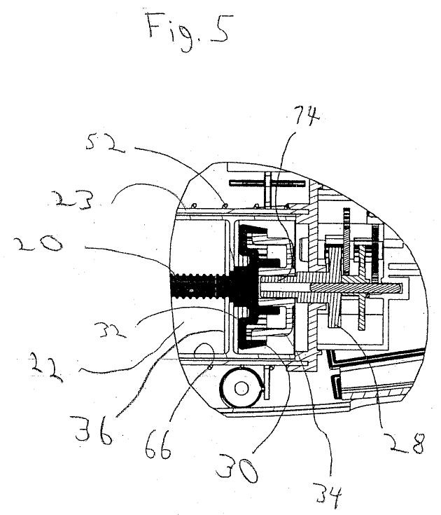

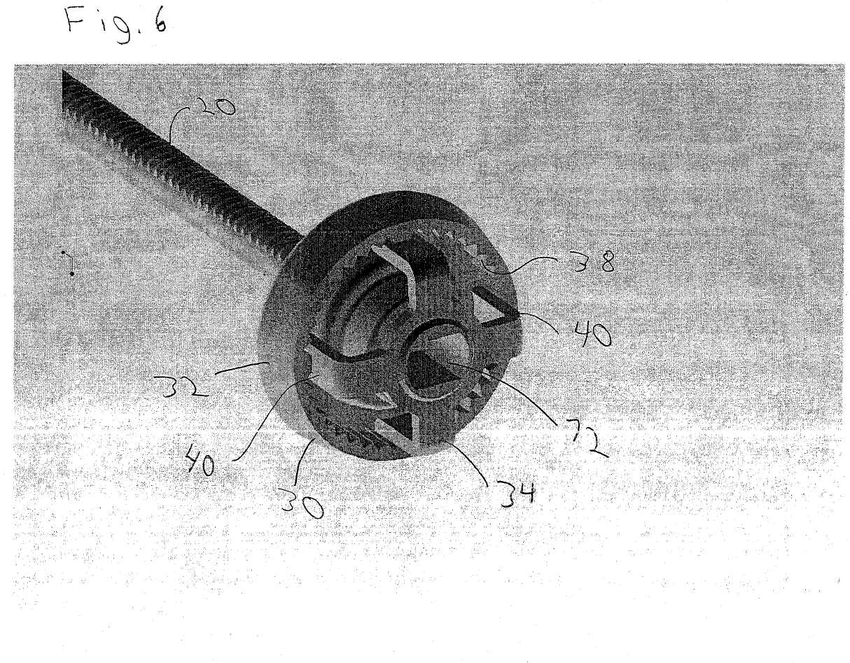

Liner 66 is preferably removable from chamber 22 in order to facilitate cleaning. With the nozzle assembly removed, a user may pull liner 66 from chamber 22. Along with the liner 66, shaft 20, piston 24 and clutch mechanism 30 may also be removed from housing 11. With reference to FIGS. 5 and 6, clutch mechanism second part 34 may include a slotted recess 72 which removably receives a drive shaft 74 extending from the gear assembly 28. The connection between drive shaft 74 and the clutch mechanism 30 results in them being rotatably coupled such that they rotate together. When the liner 66 is removed from the housing, the connection permits the clutch mechanism second part 34 and the drive shaft 74 to separate. With the liner 66 removed along with the other components that come into contact with the foodstuff, they may be easily cleaned, it is within the contemplation of the present invention that dispenser 10 could be used with or without a liner.

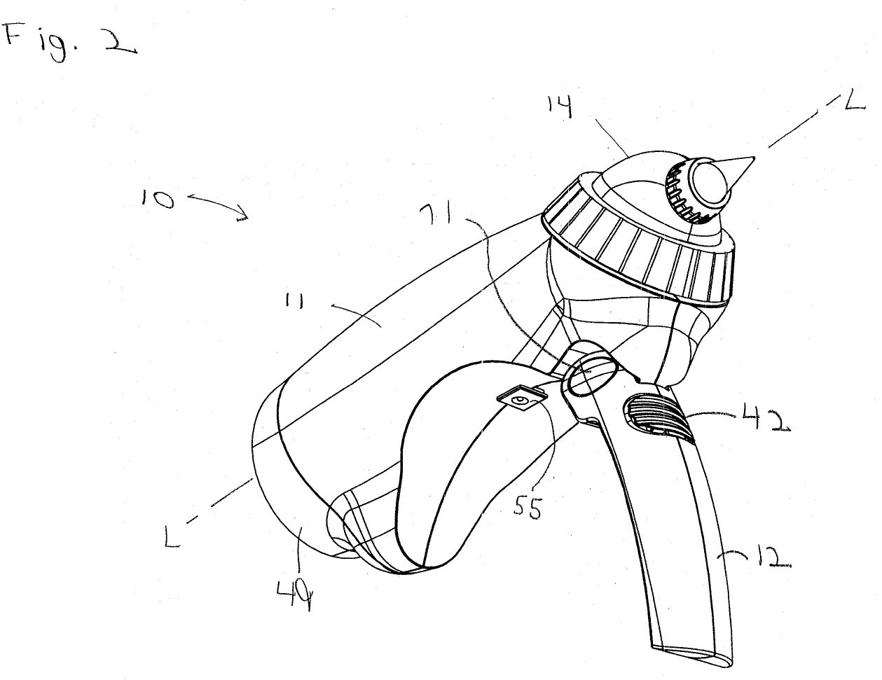

With reference to FIGS. 1-3, dispenser 10 of the present invention provides for flexibility in how a user interfaces with the dispenser. Such flexibility is preferably provided by way of the handle 12 which may be moved between a first and second operative position. As shown in FIG. 1, the handle may be rotated such that it generally aligns with the longitudinal axis of the housing 11. In this first operative orientation, the handle forms an opening 67 with the housing 11. The handle 12 can then be gripped in what is similar to holding a hand-held blender. In an alternative configuration, as shown in FIG. 2, handle 12 may be placed in a second operative position where it extends from the housing 11 at a generally perpendicular orientation. This orientation provides somewhat of a pistol grip-type of interface for the user. In each of these positions, operating switch 42 is disposed on handle 12 such that it can be easily actuated by a user. Handle 12 may be locked into both its first and second positions. A lock release button 71 may be located on the handle 12 in order to permit it to be moved between its first and second position. It is also within the contemplation of the present invention that the handle could be fixed in a single position.

In order to accommodate the various holding positions of the dispenser 10, it is desirable to change the orientation of the nozzle tip 64 which is permitted due to the removability of nozzle assembly 14 from housing 11. When the dispenser is held like a hand-held blender as shown in FIG. 1, it is desirable for the nozzle tip 64 to point downwardly in a direction generally perpendicular to the longitudinal axis L-L of the housing 11. When the dispenser is held in a pistol grip manner as shown in FIG. 2, the nozzle tip preferably points in a direction generally along the longitudinal axis L-L of the housing 11. Accordingly, the present invention permits the nozzle tip 64 to be selectively positioned between at least a first and second orientation. The first orientation is angularly offset from the second orientation. The position of the nozzle tip may be rotated by removing the nozzle assembly 14 from housing 11. This is done by rotating collar 54 such that it unthreads from the housing 11. The nozzle component 56, which includes the nozzle tip 64, may be rotated and repositioned on housing 11 in the desired orientation. The collar 54 may then be advanced in order to secure the nozzle component 56 in its orientation.

With reference to FIGS. 9 and 10, channel first end 60 is preferably surrounded by a circular first flange 82. The front end of chamber 22 is also surrounded by a circular second flange 84. The first and second flanges 82 and 84 have generally the same outer diameter. The round configurations facilitate the use of the rotating collar 54 to secure the nozzle assembly 14 to housing 11.

With reference to FIGS. 8-10 in the preferred embodiment, nozzle component 56 may be rotatably positioned on housing 11 in any position desired by the user. First and second flanges 82 and 84 may be relatively smooth such that they can slide against each other when the collar 54 is not tightly fixed to housing 11. To adjust the position of the nozzle component 56 and the nozzle tip 64 attached thereto, a user may place the nozzle component 56 on the front of housing 11 in the desired position and then screw on the collar 54 to housing thread 57 until it is tight, thereby fixing the position of the nozzle component. Once the nozzle component 56 is attached to the housing, if a user desires to change its position, they may partially unscrew the collar 54 thereby permitting rotation of the nozzle component 56. When the newly desired position is achieved, the collar 54 by re-tightened on housing 11.

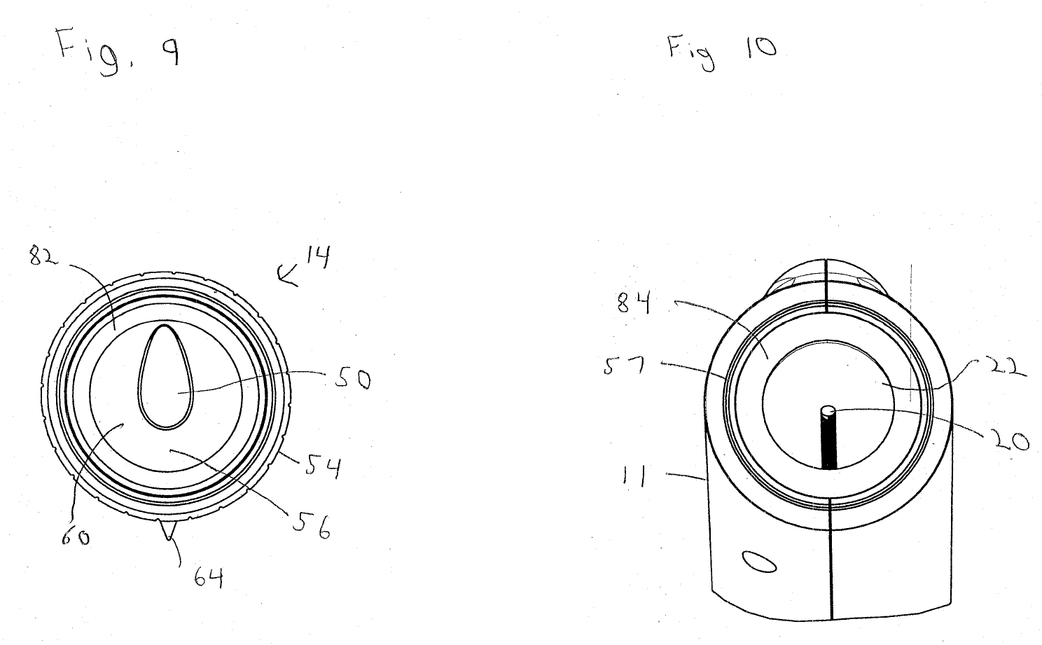

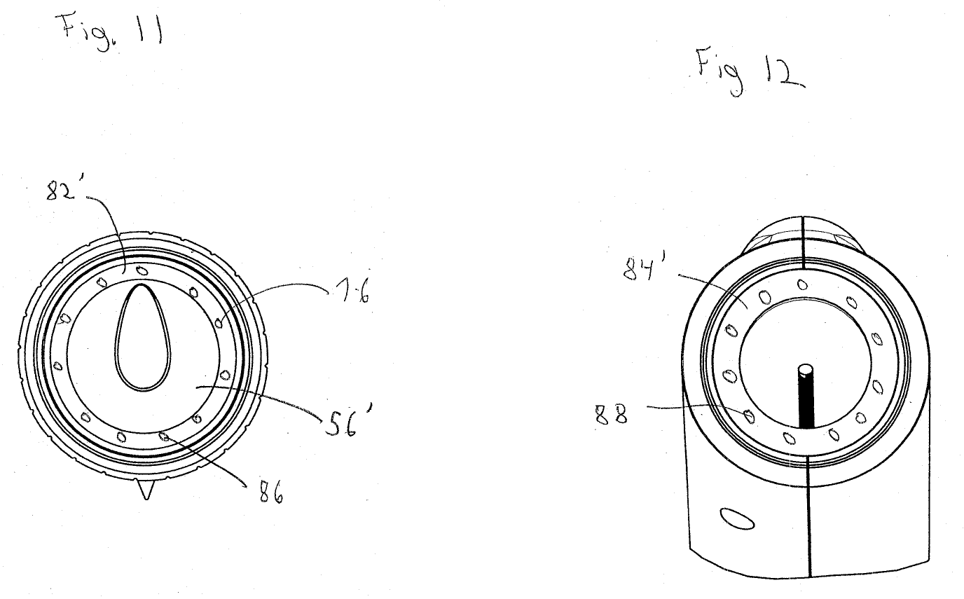

In an alternative embodiment shown in FIGS. 11 and 12, the first and second flanges 82′ and 84′ may include an aligner 76 in order to achieve specific discrete orientation of the nozzle component 56′. Aligner 76 may include a plurality of spaced protrusions 86 on first flange 82′ and a plurality of spaced indentations 88 formed on second flange 84′. The protrusions 86 ride in and out of the indentations 88 as the nozzle component 56′ is rotated. Alternatively, the protrusions may be formed on the second flange and the indentations may be formed on the first flange.

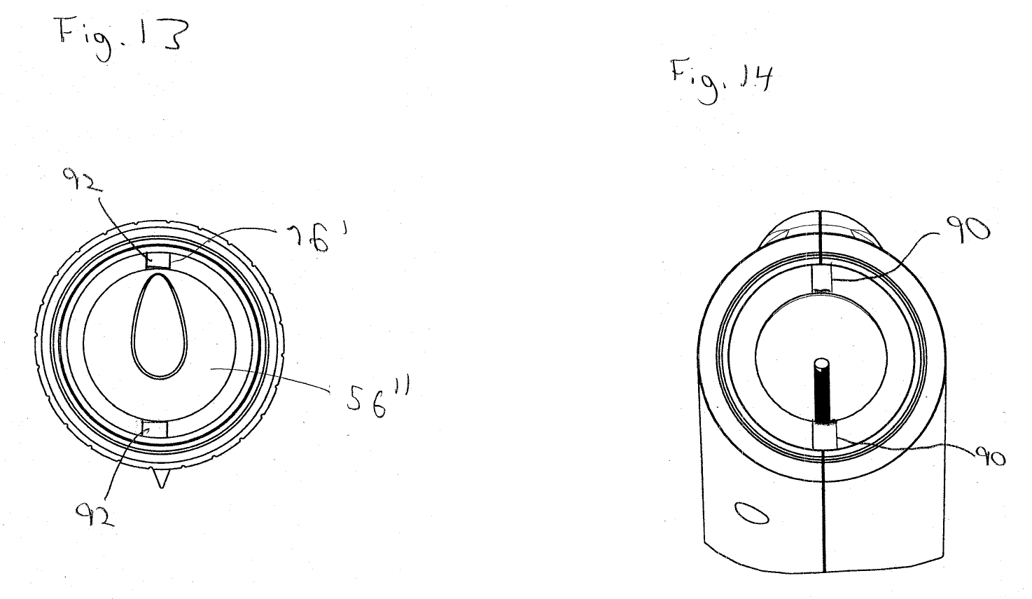

In a further alternative embodiment shown in FIGS. 13 and 14, the nozzle component 56″ may be positionable on the housing 11′ in only two orientations which correspond to how the dispenser 10 will be held. In order to achieve this two specific position feature, the aligner 76′ may include projections 90 formed on the housing which correspond with slots 92 formed in the nozzle component 56″. Unless the nozzle component 56″ is in one of the two desired orientations, it will not mate properly with the front end of the housing. The location of the projections and slots may be reversed to achieve the same effect.

In order to mate the nozzle assembly 14 to housing 11 the first and second flanges preferably have round configurations as described above. However, chamber 11 preferably has a non-round configuration to prevent piston 24 from rotating as shown in FIG. 4. In order to achieve both desired features, preferably chamber 22 ends at an angle as shown in FIG. 8. The end of chamber 22 is slanted at an angle so that the end of the chamber will be generally circular. Preferably, the shape of the chamber is a 45 degree ellipse as shown in FIG. 4. In order to achieve a round end face of the chamber, the slant angle is 45 degrees. Accordingly, the chamber's slant angle corresponds to the configuration of the chamber's cross-sectional profile. This relationship creates a generally circular configuration at the end of chamber 22 as shown in FIG. 10. Therefore, second flange 84 may have a circular shape and easily mate with first flange 82 which is also circular at any orientation. The ellipse and chamber slant angle are preferable within a range of 30 to 60 degrees. The particular angle and ellipse configuration are given here as examples and are not meant to be limiting.

With the nozzle component being fully rotatable with respect to housing 11, it is desirable to have the nozzle tip 64 angularly offset from the axis of rotation of the nozzle component. By having such an offset, the position of the nozzle tip 64 will be changed as the nozzle component rotates. For example, due to the positioning of the nozzle tip 64 on the nozzle component 56, a 180 degree rotation of the nozzle component 56 results in a 90 degree change in orientation of nozzle tip 64 with respect to the longitudinal axis L-L of the housing The difference in nozzle tip orientation is shown in FIGS. 1 and 2. In FIG. 2, the nozzle tip 64 is generally in line with the longitudinal axis of housing 10. In FIG. 1, the nozzle tip 64 is generally perpendicular to the longitudinal axis of housing 11. A user may achieve other nozzle tip 64 positions by rotating the nozzle component 56 with respect to the housing 11.

In operation, a user of dispenser 10 would set the selector switch 44 to the reverse position and actuate operating switch 42 until the piston 24 is fully returned to its initial position. When the piston has returned to its initial position, clutch mechanism 30 will make a clicking sound advising the user of the piston's position, and the operating switch 42 may be released. The user may then unthread collar 54 in order to remove nozzle assembly 14 from housing 11. Foodstuff may then be poured into chamber 22. The nozzle component 56 may be refitted to housing 11 in the desired orientation. The collar 54 may be advanced onto the threads 57 of the housing in order to secure the nozzle component 56 to housing 11. The user may then place handle 12 in the desired operative position for use.

If the foodstuff to be dispensed is solid at room temperature, the user may connect plug 53 to a power source and to connection 55 in order to energize heating element 52. After a desired pre-determined amount of heating time has elapsed so that the foodstuff is melted, the dispenser 10 may be unplugged from a wall outlet. If the foodstuff is flowable at room temperature, such as icing, then there would be no need to plug in the device to actuate the heating element. The user may then move the selector switch 44 into one of the desired operating positions such as low, medium or high, depending upon the flow rate desired. The user may then grab the dispenser 10 to hold it in the desired position. The operating switch 42 may then be actuated in order to begin dispensing the foodstuff. As the operation switch 42 is activated, motor 18 is connected to power source 46 and the threaded shaft 20 rotates, causing piston 24 to move forward and dispense the foodstuff from the nozzle tip 64.

A user may change the manner in which they hold dispenser 10 by maneuvering handle 12 between either of its first or second operative positions. The orientation of the nozzle tip may also be changed in order to conform to the desired manner of holding the device.

The user may continue to actuate the operating switch 42 to dispense the foodstuff. The dispenser 10 of the present invention provides a uniform flow rate of dispensed foodstuff and provides a user with a choice of positions in order to grip the device and use it in the manner as desired. Both of these features give the user optimal control find facilitate decorating. The piston 24 will continue advancing until the operating switch is released or until the piston reaches the end of its travel. At the end of the piston travel the shaft 20 will rotate, vet the piston will no longer advance and the foodstuff will, stop dispensing. This will, indicate to the user that the chamber 22 is empty. The user may then change the position of the selector switch 44 such that the operating switch 42 causes the piston 24 to return to the retracted position so the dispenser 10 may be refilled.

In order to clean the dispenser 10, a user may remove the nozzle assembly 14 and remove liner 66 and the shaft 20 and piston 24 along with the clutch mechanism 30. These components which come in contact with the foodstuff may then be cleaned manually or in a dishwasher.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A hand-held dispenser of foodstuff comprising:
a housing including an interior chamber;
an outlet in communication with the chamber;
a motor disposed within the housing;
a drive mechanism operably associated with the motor for moving foodstuff within the chamber toward the outlet; and
a handle movably disposed on the housing between a first operative position and a second operative position, the handle and housing defining a hand opening when the handle is in the first operative position.

2. The dispenser of claim 1, wherein the drive mechanism includes a piston disposed within the chamber which is translatable toward and away from the outlet.

3. The dispenser of claim 1, further including a heating element in thermal communication with the chamber for melting the foodstuff.

4. The dispenser of claim 2, wherein the piston cooperates with the chamber to prevent the piston from rotating.

5. The dispenser of claim 4, wherein the piston has a non-round configuration and the chamber has a non-round configuration.

6. The dispenser of claim 5, wherein the chamber has an elliptical configuration.

7. The dispenser of claim 1, wherein the outlet includes a nozzle assembly removably disposed on the housing and in fluid communication with the chamber.

8. The dispenser of claim 7, wherein the nozzle assembly is positionable on the housing in a plurality of orientations.

9. The dispenser of claim 8, further including an aligner for positioning the nozzle assembly at predetermined positions with respect to the housing.

10. The dispenser of claim 7, wherein the nozzle assembly includes a removable nozzle tip.

11. The dispenser of claim 2, wherein the drive mechanism includes a threaded shaft operatively connected to the motor and extending into the chamber, the shaft being in threaded engagement with the piston.

12. The dispenser of claim 11, wherein the drive mechanism includes a clutch disposed between the shaft and the motor.

13. The dispenser of claim 12, wherein the piston, shaft and clutch are selectively removable from the housing.

14. The dispenser of claim 1, further including a first switch operably connected to a power source and the motor for activating the motor.

15. The dispenser of claim 14, further including a second switch for effecting the operation of the motor.

16. The dispenser of claim 1, further including a liner removably disposed within the chamber and extending along a length thereof.

17. A hand-held dispenser of foodstuff comprising:
a housing including an interior chamber;
a nozzle in communication with the chamber;
a piston disposed within the chamber and translatable toward and away from the nozzle; and
a drive mechanism including a motor, the drive mechanism being operably connected to the piston for moving same, and wherein the piston cooperates with the chamber to prevent relative rotation between the piston and chamber.

18. The dispenser of claim 17, wherein drive mechanism includes a shaft disposed within the chamber and extends along a length thereof the shaft is operably connected to the motor and the piston wherein rotation of the shaft causes the piston to translate within the chamber.

19. The dispenser of claim 18, wherein the shaft is threaded and the piston cooperates with the threaded shaft to permit translation of the piston upon rotation of the shaft.

20. The dispenser of claim 17, further including a heating element in thermal communication with the chamber for melting the foodstuff.

21. The dispenser of claim 20, wherein the heating element includes a coil extending along a portion of the length of the chamber.

22. The dispenser of claim 20, wherein the motor is operably connected to a first power source and the heating element is operably connected to a second power source.

23. The dispenser of claim 20, wherein the motor and the heating element are operably connected to the same power source.

24. The dispenser of claim 17, further including a handle disposed on the housing and movable between a first and second operating position.

25. A hand-held dispenser of foodstuff comprising:
a housing including an interior chamber;
a nozzle component in communication with the chamber, the nozzle component being selectively positionable between at least a first and second operating position, wherein the first position is angularly offset from the second position; and
an extruding device including a motor for moving the foodstuff through the nozzle.

26. The dispenser of claim 25, wherein the chamber has a non-round cross-sectional profile and the nozzle component includes a channel in communication with the chamber.

27. The dispenser of claim 26, wherein she chamber his an elliptical cross-sectional profile.

28. The dispenser of claim 27, wherein the chamber has an end portion slanted at an angle.

29. The dispenser of claim 28, wherein the slatted angle of the chamber is determined by the cross-sectional profile of the chamber.

30. The dispenser of claim 28, wherein the end portion of the chamber is circular.

31. The dispenser of claim 27, wherein the elliptical cross-sectional profile is in the range of 30 to 60 degrees.

32. The dispenser of claim 25, further including an aligner for positioning the nozzle component in the at least first and second operating positions with respect to the housing.

33. The dispenser of claim 25, wherein the nozzle includes a collar which engages the housing to secure the nozzle thereto.

34. The dispenser of claim 25, wherein the nozzle component includes a nozzle tip removably secured thereto.

35. The dispenser of claim 31, wherein the nozzle tip is disposed on the nozzle component offset from the nozzle component's axis of rotation relative to the housing.

36. The dispenser of claim 34, wherein the housing includes a removable portion, and removal thereof provides access to a compartment for storing nozzle tips.

37. The dispenser of claim 25, wherein the extruding device includes a piston translatable within the chamber for extruding the foodstuff out of the nozzle.

38. The dispenser of claim 37, wherein the extruding device further includes a shaft extending along a length of the chamber, the shaft cooperating with the piston such that rotation of the shaft causes the piston to translate within the chamber.

39. The dispenser of claim 25, further including a handle movable between a first and a second operative position.

40. A hand-held dispenser of foodstuff comprising:
a housing including an interior chamber;
an outlet in communication with the chamber;
a motor disposed within the housing;
a drive mechanism operably associated with the motor; and
a liner removably insertable within the chamber, the liner including a longitudinally extending side wall and a back wall, foodstuff being disposable within the liner, wherein the drive mechanism moves the piston to dispense the foodstuff out of the outlet.

41. The dispenser of claim 40, wherein the liner side wall has generally the same cross-sectional profile as the chamber.

42. The dispenser of claim 40, wherein the drive mechanism includes a shaft extending into the chamber, and the liner has an opening for receiving the shaft.

43. The dispenser of claim 40, wherein the piston and shaft are removable from the housing.
